(19) United States
(12) Patent Application Publication
(10) Pub. No.: US 2005/0035070 A1
(43) Pub. Date: Feb. 17, 2005

(54) Device and method for the removal of oil or floating materials from a water surface

(76) Inventor: Richard Egli, Dorfstrasse (CH)

Correspondence Address: Adams & Wilks, 31st Floor, 50 Broadway, New York, NY, 10004, US

(21) Appl. No.: 10/491,350

(22) PCT Filed: Apr. 17, 2003
(86) PCT No.: PCT/CH02/00433

(30) Foreign Application Priority Data
Oct. 4, 2001 (CH) 1839/01

(51) Int. Cl. C02F 1/40

(52) U.S. Cl. 210/776

(57) ABSTRACT

An installation and a process for removing floating fluids and materials, particularly oil, from the water surface is recommended, whereby between two floats, specifically of a catamaran (11), a turn around cylinder and a driving cylinder, which is driven preferable by a bladed wheel (4), are mounted. Around the cylinders an endless band (1) is moved. The oil is absorbed from the water surface (30) preferable by capillary forces in a honey comb structure of the endless band (1). The oil is discharged preferable by blowing down with a compressed air nozzle (5) and discharging in a sump (7). The catamaran is preferable pulled by a tug boat with a tug rope and is steered by a steering rope. The compressed air to the catamaran as well as the suction of the oil is supplied from the tug boat.

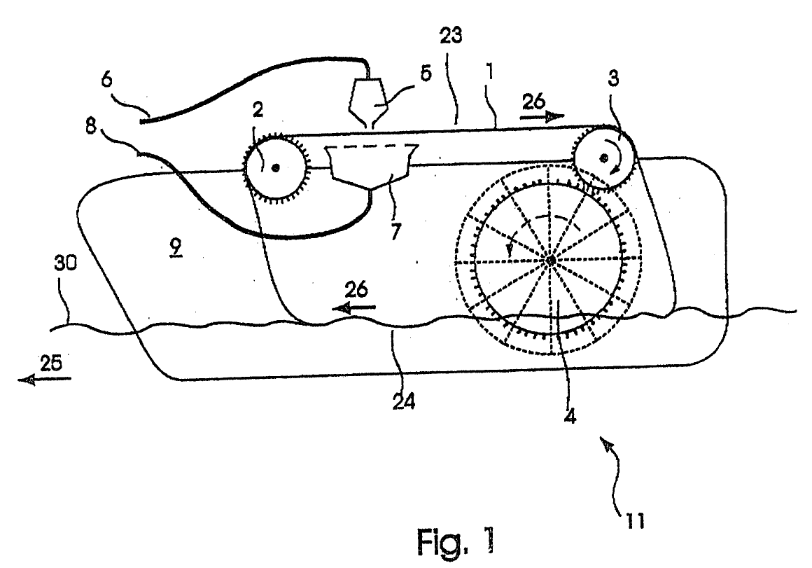

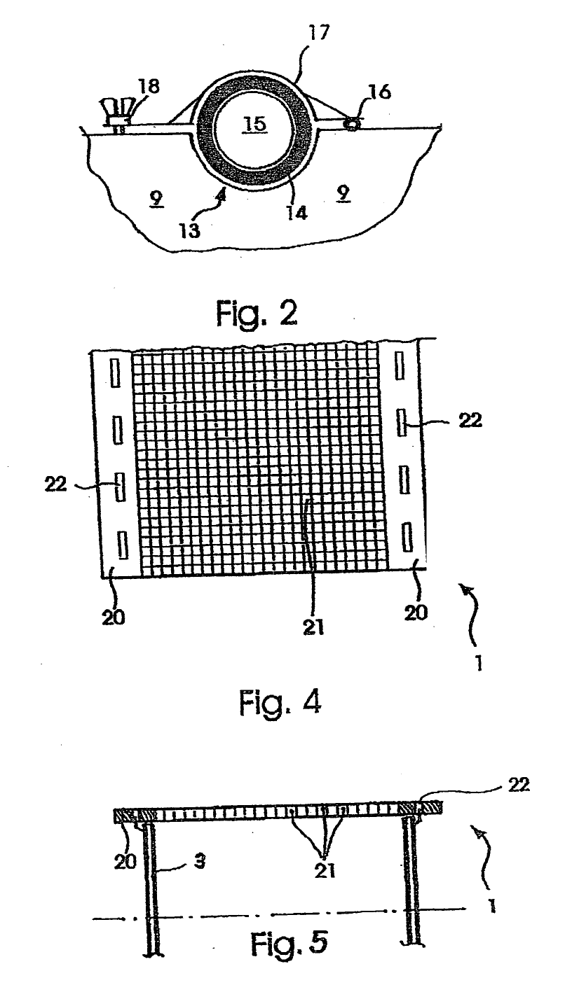

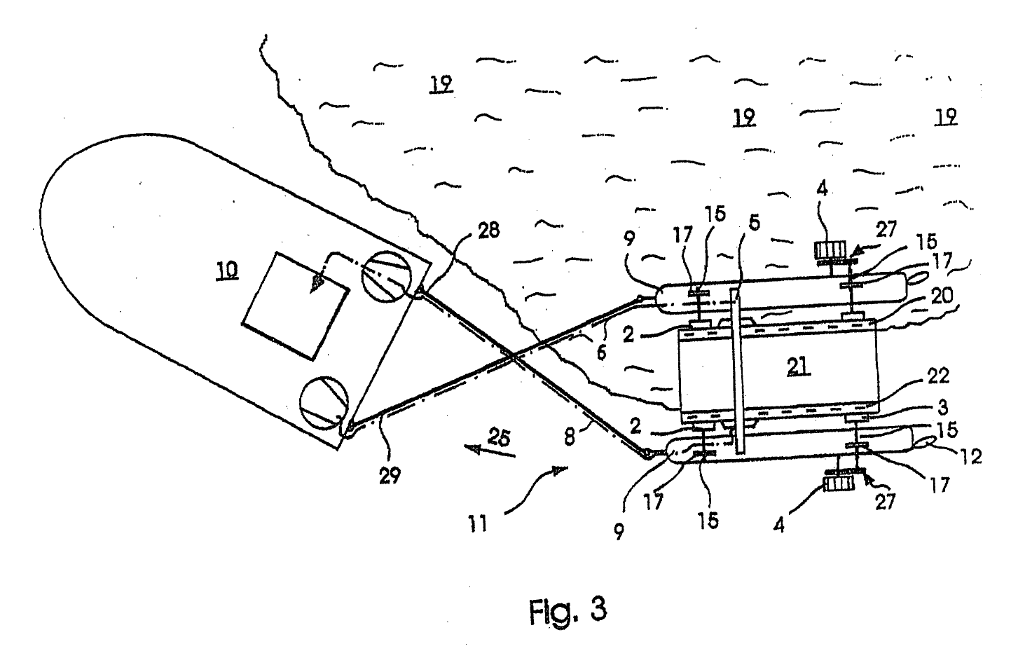

The invention deals with an installation and process to remove oil, oil alike material, floating material from the water surface. Especially on open sea, preferable with an endless band, which, for taking and discharging of the fluids, and/or material, is rolled around at least two cylinders.

The great need of mineral oil products like fuel and lubricants as well as basic material for the chemical industries in the industrial countries means a high transport capacity by the oil producing countries to the oil consumption countries. Due to accidents or other unforeseen circumstances a loss of larger quantities of oil has occurred. Also little oil or oil alike fluids can pollute the water surface by negligence or disregarding instruction for instance during maintenance on ships. This can produce an, oil carpet on the water surface, which may endanger the water biology as well as the shore region considerably, especially as little oil quantities are building large oil carpets. Therefore it is important to dispose of effective processes and installation to remove such oil carpets and to clear the oil from the water surface caused by accidents, defects or disregarding protection rules.

Next to pure chemical processes, which precipitate the oils, also processes and installations with mechanical components are applied. The equipment uses oil absorbing materials, which are piece by piece put on the water surface on a complicated and costly way and the oil finally removed (squeezed) possibly to be used again. Furthermore also continuous process for removing oil with absorbing and releasing materials are known.

According to DE 3913575 a process for absorbing and separating fluids, fluid mixtures and granular materials are known. In this process a plastic matt with a honeycomb cell-structure, is put on the water surface, whereby the oil is generally absorbed in the honeycomb cells through expansion of the cells and/or contraction of the cell walls.

The oil discharge from the honeycomb cells is normally realised through compression of the cells and/or expansion of the cell walls. This leads to make use of the following process: a honeycomb matt with a width of about three meters is dropped in the water from a ship. By putting weights on the honeycomb matt it will dive generally under the oil carpet facilitating the absorption of the oil. Afterwards the matt is retracted back to the ship. Then the matt will be compressed, e.g. in a funnel enabling to drain the oil in the ship. Equipment for heaving and lowering the matt can as well be placed at the bow as at the stern; on expensive special ships also on either side of that ship.

In addition to the above described procedure the honey comb matt can also be fitted as an endless band on two cylinders on the longer sides of a specialised ship, whereby one of the two cylinders also may act as a driving cylinder, being driven by the bladed wheel in the water, so that the honeycomb matt moves only with the same speed as the ship as there no transmission in between. The matt therefore does not move relatively to the water surface. The matt is afterwards compressed in the funnel and the oil drips in a suitable oil sump, located underneath the funnel.

When using a mechanical process the positioning of the various oil taking and-spilling elements is extremely complicated and costly as the various parts often can only positioned and collected manually, which is connected with high personnel costs and physical strength.

When the manual positioning is not necessary, the physical strength may be obsolete, but must be replaced by complicated and expensive technical installations and still hardly can operate continuously.

Should however the oil be taken in a continuous process, then a complicated and expensive ship with the necessary equipment will be required. And as this ship with the expensive maintenance and initial cost cannot be used continuously, but only then when an oil pollution has occurred the operational costs will be very very high. In addition this ship has to sail to the area of pollution which brings additional costs whereas this ship cannot be used in inland water. During the oil absorption the oil carpet will be, due to the arrangement of the oil absorbing elements alongside the ship, unfavourable divided, so that the oil carpet is drifted to the wall, which can cause considerable damages.

As a conclusion, the invention will have the task to create a device and a process to remove oil from the water surface, eliminating the disadvantages as described above, to pick-up the oil, without splitting the oil carpet, with a simple device that has an easy entry to the waters.

This task is solved by an installation for removing oil, oil similar fluids, floating fluids and floating materials from the water surface according to the features of the patent claim 1, respectively a corresponding procedure according patent claim 12. Advantageous arrangements are the subject of the subclaims.

According the invention a rotating endless band is located between two floats, preferable a catamaran, which is tugged by a boat, or moved by other methods, during which the fluids and/or materials on the water surface are continuously absorbed by the endless band.

For the absorbing endless band preferable a fleece band, as a combination of cellulose, especially waste paper cellulose, reinforced with hemp fibres, is being used. This material has a hollow space structure, particularly a capillary respectively honey comb structure, which enables to absorb the fluids by capillary forces whereby the hollow space geometry, in particular the size of the honey comb, is adapted to the viscosity of the fluid. Also already known materials, e.g. plastics, can be used. The advantage of the use of hemp fibre is mainly, that it can be easily destroyed after being used. Plastic materials can be washed out and be used again.

The endless band preferable shows a construction with carrier straps and holes on both sides.

Between the carrier straps the actual fleece with the honey comb structure for absorbing the substance is mounted. Both sides of the cylinders have teeth, which fit into the holes in the straps, so that the motive power between the cylinders and the fleece is form fitting. In addition the thickness of the carrier straps is less than that of the honey comb, whereas the carrier straps at the honey comb structure are so arranged that one side is in contact with the cylinder. Because of this flexible connection the endless band matches the roundness of the cylinders.

When using a catamaran the absorbing endless band, especially the fleece band, is supported by the two or more cylinders between the both floating bodies of the catamaran.

The cylinders are located preferable above the water surface so that the endless band sags on to the water. The endless band is preferable driven by the rear cylinder, which also drives the endless band. The drive is preferable made by one or two bladed wheels on the outside of the floating bodies of the catamaran. Besides the drive by bladed wheels also by other drives like pneumatic or hydraulic drives are possible, which are specially transferred from the tugging or pushing ship to the catamaran by supply lines. When using compressed air a compressed air turbine with a reduction gear will be mounted to the catamaran, controlling the speed of the endless band is simply made by a pressure reducer.

It is preferred that the driving cylinder is driven by a transmission gear from the bladed wheel. It is also possible to make use of encased chain—or belt drives, which can change the rotating direction of the driving cylinder, if required. By using gear wheels on the shafts of the bladed wheels and the driving cylinder of different sizes, a decreasing or increasing transmission can be realised, thus changing the speed of the endless band. This allows for a optimal adaptation to the speed of the fluid absorption, e.g. crude oil, light oil, or petrol. The mounting of the required gear wheel is normally made ashore, after having determined the kind of fluid to be absorbed by taking samples.

The bearings of the turn around cylinders are positioned on a very simple way on the upper side of the floating bodies of the catamaran. The floating bodies have on the upper side a small hollow spot where the bearing of the shaft of the cylinder can be put and easily be fixed by means of a clamp. This clamp is for instance on one side hinged with the floating body, on the other side fixed with a wing nut. This enables the operator to assemble and disassemble the transport cylinder with its bearing by just swivelling the clamp and to screw or unscrew the wing nut.

The endless band is moved over the two turn around cylinders generally in the same direction as the floating bodies, however because of the change ability of the driving speed by the gear transmission a band speed different from the water surface can be set in order to obtain a more efficient absorption of the oils, oil similar fluids or floating materials due to the fact that the lower part of the endless band can float more favourable on the water surface.

The pollution can be absorbed on different ways i.e. by true absorption, adhesion, hygroscopic-, chemical action and electrostatic charge.

When using a endless band with hollow space structure, especially capillary or honey comb structure, the absorption takes place by capillary forces. The fleece band floats on the water surface and will not be pushed under the water surface, as it is the case with conventional methods, so that the absorption is more and better warranted.

The discharge of the absorbed materials takes preferable place between both turn around cylinders on the upper part of the endless band which is supported by e.g. swinging, knocking, flushing, brushing or squeezing. The rest of the residue is removed by cleaning with compressed air whereby under the compressed air nozzle a collecting sump is fitted.

The blown-out oil then splashes or drips in the sump, on which normally a suction hose is attached who transfers the separated oil to and in a tug—or escort boat

The catamaran is mostly moved by a tugboat. Two ropes are preferable attached on both sides of the rear of the tugboat and also on the both outsides of the bow of the catamaran. Both ropes should be crossed. To encircle for instance a circular oil carpet, with the purpose of absorbing the oil, the outer rope of the catamaran is taking the pull function. The second rope will then steer the catamaran. Both ropes, who take the function of either pulling or steering, serve generally as a support of the suction hose for the oil sump and the compressed air nozzles as also further supply lines, e.g. E-cables for electricity supply and steering. For additional steering a rudder can be attached to the both floats, which can be controlled from the tugboat This way the absorption of a oil carpet part can be absorbed in a undivided track, so that an additional tracking is not necessary. In order to avoid accumulation and sedimentation of oil, especially due to the Lotus-effect, the floats will have to be protected by a dirt-repulsing painting.

Next to this kind of connection between the tugboat and catamaran, also other current connections between two ships are possible, for instance with flexible or rigid rods attached to either side of the tugboat.

In addition the catamaran can, when it is in small inland waters, also be moved with ropes and stationery installation on land, by pulling and slacken the ropes. In the case of flowing water (river, etc) the catamaran can be fastened to the wall only, as the relative movement between the flowing water and the catamaran is already sufficient.

Hereafter a performance example wail be, with reference to the drawings, in more detail explained and described.

Drwg 1—a longitudinal section of the catamaran.

Drwg 2—a cross section of the bearing part of the shaft on the turn around cylinders of the catamaran.

Drwg 3—a view on a tug boat with catamaran.

Drwg 4—a view on the endless band.

Drwg 5—a cross section of the endless band

Drawing 1 shows the longitudinal section of a catamaran (11) with one of the two floats (9). A endless band (1) for absorbing the oil rolls with an endless movement around the front cylinder and the rear driving cylinder (3), which is attached to the upper part of the float (9). The catamaran (11) is pulled by the tug boat (10) (see drwg 3) resulting in a moving direction (25). Due to the movement of the catamaran (11), a bladed wheel (4), which is located on the outside of float (9), is driven. The shaft of the bladed wheel (4) drives via a transmission speed-increasing and reduction gear, the driving cylinder (3) and thus the endless band (1). The endless band (1) moves on the water surface in the opposite direction of the movement of the water surface (30) relative to the moving direction (26) of the catamaran (11). The endless band (1) runs therefore in a relative movement of the water surface (30) with a speed corresponding the sum of the moving speed of the catamaran (11) and the moving speed of the endless band. By choosing a adequate increasing- or reducing speed rate between the bladed wheel (4) and the driving cylinder (3), by the transmission gear (27) (see Drwg 3), the speed of the endless band (1) relative to the water surface (30) can be adapted to the kind of fluid (e.g. crude or light oil) to be absorbed.

In addition an adaption of the capillary size of the endless band (1) to the kind of fluid will be made.

The catamaran (11) is assembled on land. Therefore a sample of the discharged oil should be taken beforehand. For the cleaning procedure the endless band (1) will sag from the turn around cylinder (2) and the driving cylinder (3) to the water surface (30), so that the endless band (1) floats on the water surface (30) and the oil carpet can be absorbed easily. The lower band part (24) then will pick up the oil. The absorption capability of the endless band (1) is optimised due to the floating on the water surface. The floating of the endless band (1) on the water surface is always guaranteed as small waves will be equalised by the endless band (1) himself, as shown as a waved line on drwg (1). Bigger waves are equalised by the catamaran (11) or its floats (9), in particular due to its small and light construction.

The absorbed oil from the capillaries (21) of the endless band (1) discharges at the upper part of the band (23) by blowing down with an slanting nozzle (5). The compressed air, preferable provided by an air compressor, is furnished via an air hose (6) from the tug boat (10) to the air nozzle (5) to the catamaran. The blown down oil is collected in a sump (7) underneath the upper part of the band (23) and is led via a vacuum hose (8) to the tug boat (10) and there stored in an oil tank, indicated by a semicolon line on drwg 3.

Drwg 2 shows a cross section of the clamping of the shaft (15) of the turn around and driving cylinder (2, 3) to the float (9). For this, the float (9) has on the top side a hollow spot, to accommodate a bearing (14), in particular a slide bearing for supporting the shaft (15). This bearing is fixed to the float (9) by a hinged clamp (16) and a wing nut connection (18). The junction can be loosened or fixed easily by loosening or fastening the wing nut (18). For disassembling the turn around—and driving cylinders (2,3) only the wing nuts (18) have to be loosened and the clamp be opened. For assembling the reverse procedure has to be followed. This enables an extreme simple assembly of both the turn around—and driving cylinder (2,3) between the both floats (9) and thus also a simple connection of both the floats one to each other and to the catamaran (11).

In drwg 3 shows a view on the catamaran (11) with the tug boat. The two floats (9) of the catamaran (11) are bilateral connected by the front turn around cylinder (2) and the rear driving cylinder (3). On these two cylinders is the endless band with the fleece of average capillary scope (21) (see also drwg 4) and a carrier band (20). This carrier band is provided holes (20), in which the teeth on the cylinders (2,3) are gearing, enabling to build a real gut connection between the endless band (1) and the cylinders (2,3). A slipping is therefore impossible. The shaft (15) of the driving cylinder (3) is driven with the gear wheels (27), which on their turn are driven by the bladed wheels on both sides of the catamaran. The absorbed oil from the endless band (1) removed over the total width by the compressed air nozzles (5).

The catamaran (11) moves in the shown direction (25) and is connected with the tug boat (10) with two ropes (28,29), which are fastened crosswise on the corresponding angles at the stern of the tug boat and at the bow side of the catamaran. The pulling rope (28) takes care of the pulling forces and the steering rope (29) steers the catamaran (11) to sail around the oil carpet (19) as shown on drwg 3 with a wave line. In addition a side rudder (12) is located at the float ends, which can be controlled from the tug boat. The supply and discharge lines for the catamaran (11), i.e. the compressed air hose (6), the suction hose (8) and the steering lines for the side rudder (12) are fastened along the ropes (28,29). On the tug boat (10) only an air compressor, an oil tank with suction pump and a control unit for the side rudders (12) have to be installed.

By sailing around the oil carpet (19) the oil can be absorbed entirely, as there is no splitting of the oil carpet by a former track and the absorption takes place on unused areas. Due to the large width of the endless band (1), the absorption and cleaning goes fast and economically with a small number of turn's.

Drwg 4 shows a view on the endless band (1). It consist of the capillaries in honey comb structure, which absorb the oil by capillary forces. Thereto are the size of the capillaries (21) adapted to the viscosity of the oil to be absorbed. At the both rims of the endless band (1) carrier straps (20) are fitted with holes in it, in which the teeth of the cylinders (2,3) are gearing, and which enables a real gut connection between the cylinders (2,3) and the endless band (1).

As material of the endless band (1) hemp fibre reinforced waste cellulose is used. This has the advantage that the endless band (1) can be discharged after being used one time. Drwg 5 shows a cross section of the endless band (1), turning around one of the cylinders, in this case the driving cylinder (3), as shown schematically.

All together with the above outlined invention an installation and process for removing oil or other material from the water surface is made available, being able to absorb large quantities of oil on a simple inexpensive way. Especially advantageous is the mobile activity, as the catamaran with its accessories can be easily assembled and dismantled and therefore easily transported on land, on water and if required by air freight. This way polluted places like waters, or also small lakes can be reached without loosing unnecessary and for the nature harmful time and free these from the pollution. The costs are considerable lower, as a complicated special ship must not be built and permanently be available for action. Only the two floats or a mobile catamaran are required. Their floats are easy transportable and simple to be treated, i.e. assembly, dismantling and maintenance, especially when they are provided with an anti oil/dirt paint, the so called lotus-effect coating.

1. Device for the removal of oil, oil-similar materials, swimming liquids or swimming solids of a water surface with a continuous belt, which is circulating arranged around at least two rollers for the admission and delivery of the liquids and/or solids, whereby the continuous belt is arranged between two floatation chambers by the fact characterized that in each case those exhibit at least two rollers (2, 3) and axle (15), which are stored at the top side of the flotation chambers (9).

2. Device according to requirement 1, by the fact characterized that the store takes place in a hollow (13) at the top side of the floatation chambers (9).

3. Device according to requirement or 2, by the fact characterized that the axles (15) are connected with the flotation chamber with a clip, or a fastening loop (17), whereby the clamping or fastening loop in particular exhibits on one side a joint (16).

4. Device after one of the preceding requirements, by the fact characterized that the floatation chambers (9) are formed as catamaran (11), whereby the rollers (2, 3) with the continuous belt (1) are arranged between the floatation chambers (9) of the catamarans (11).

5. Device after one of the preceding requirements, by the fact characterized that one of the rollers (2,3) is designed as a returning roller (2) and the other roller as driving roller (3).

6. Device according to requirement 5, by the fact characterized that for the move of the driving roller (3) a vane (4) is intended, whereby the continuous belt (1) moves in direction of the motion (25) of the flotation chambers (9) to the water surface (30).

7. Device according to requirement 6, by the fact characterized that the driving roller (3) of the vane (4) is propelled over a transmission, in particular by two gear wheels (27).

8. Device according to requirement 7, by the fact characterized that the transmission (27) different speed ratios are adjustable for the adaptation to the relative velocity between continuous belt (1) and water surface (30).

9. Device after one of the preceding requirements, by the fact characterized that for the admission of the liquid or the solid at the continuous belt (1) a fleece with cavity structure is intended, preferably with capillaries (21) or honeycomb structure.

10. Device after one of the preceding requirements, by the fact characterized that for the delivery of the liquid or the solid at the continuous belt (1) at least a compressed air nozzle (5) is intended, whereby the compressed air supply preferably takes place from a dragging ship (10) from a compressed air hose (6).

11. Device after one of the preceding requirements, by the fact characterized that for the admission of the delivered liquid or the solid a catching pan (7) is intended, whereby preferably a suction hose (8) is intended to a dragging ship (10).

12. Device after one of the preceding requirements, by the fact characterized that the floatation chambers are movable (9) from a dragging ship (10), preferably via pulling on a dragging cable over-crossing in the respective nose or tail range.

13. Device after one of the preceding requirements, by the fact characterized that a contamination-restraining coating is used for the surface of the floatation chambers (9).

14. Procedure for the continuous removal of matters of a water surface via admission and delivery with a continuous belt, whereby the continuous belt that is carried by the flotation chambers is arranged swimming between the flotation chambers, by the fact characterised that a device is used after one ore more of the preceding requirements.
